(19) United States
(12) Patent Application Publication
(10) Pub. No.: US 2008/0235049 A1
(43) Pub. Date: Sep. 25, 2008

(54) Method and System for Predictive Modeling of Patient Outcomes

(75) Inventors: Mark Morita, Arlington Heights, IL (US); Steve Lawrence Fors, Chicago, IL (US); William Douglas Hughes, Bainbridge Island, WA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, SCHENECTADY, NY (US)

(21) Appl. No.: 11/690,589

(22) Filed: Mar. 23, 2007

(51) Int. Cl. G06Q 50/00

(52) U.S. Cl. 705/2

(57) ABSTRACT

A method and system for predictive modeling of patient outcomes. The predictive method includes the steps of applying an algorithm to patient data and displaying predicted patient data. The predictive method may further include the step of adjusting one or more clinical variables. The system includes a database of patient data, a rules engine operably connected to the database wherein the rules engine is capable of applying algorithms to the patient data to generate predicted patient data, and a user interface operably connected to the database.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Embodiments of the present method and system relate generally to the field of data processing to facilitate medical diagnosis and treatment. Specifically, embodiments of the present method and system relate to predicting relevant clinical information based on historical trends and interventional plans.

In the modern healthcare environment, considerable amounts of patient data are generated during the course of a given patient's interactions with healthcare providers. The data consists principally of measured variables collected during patient observations, diagnoses, and treatments. For example, patient vital signs, laboratory test values, and other relevant measurements are entered into various computer systems at various points in time. Collectively, this data presents a historical picture of patient health.

Modern healthcare facilities typically manage these considerable amounts of patient data via computer systems. These computer systems are often networked systems having data stores or databases and workstations allowing clinical users to view patient data. Historical patient data may be displayed as isolated data points. For example, FIG. 1 illustrates a user interface displaying historical data chart 100 for a fictional patient. In FIG. 1, the patient's vital signs, such as heart rate, respiratory rate, and blood pressure are displayed in a user interface window. Other clinical variables related to laboratory testing, medications, and diagnostic imaging are also available through the user interface.

Moreover, historical patient data may also be displayed as data trends. That is, the measurements of a given variable or set of variables may be displayed as a function of time. By displaying historical patient data in this way, a clinician may gain insight into the variation in a patient's condition over time. For example, FIG. 2 illustrates a user interface displaying a historical trend chart 200 for a fictional patient. In FIG. 2, clinical variables such as the results of laboratory testing for levels of low-density lipoprotein (LDL) and other biological markers associated with Type-2 diabetes are displayed as a function of time. In reviewing such a display of data trends, a clinician may observe historical trends in the patient's condition that may not otherwise be readily apparent in the data display of FIG. 1.

Displaying trends in a set of historical patient data over time also provides a clinician with a view of how different measured variables may have varied in relation to each other over time. For example, a clinician may be able to observe how a patient's weight and cholesterol levels have followed a similar trend over a certain period of time. While such a combination of trends in measured variables is helpful to a clinician, what is missing is a system capable of predicting and displaying patient data based on historical patient data trends.

One element useful for predicting future patient data based on historical patient data is a clinical framework or a set of clinical guidelines for modeling such data. Through analysis of clinical experience with diagnosis and treatment of patient conditions, a framework for decision-making related to patient treatment can be established. Clinical trials of pharmaceuticals, for example, provide data regarding patient outcomes. Actual clinical use of the same pharmaceuticals provides further data regarding such outcomes. By synthesizing the accumulated data related to a certain pharmaceutical, a clinical framework for modeling the use of that pharmaceutical in patients can be developed.

Moreover, the outcomes for a given patient may depend on a range of other variables that may have their own clinical guidelines. For example, the framework or guidelines for the management of a patient's blood pressure may indicate generally a potentially negative interaction with certain pharmaceuticals. However, close study of the clinical framework for that certain pharmaceutical may indicate a therapeutic dosage window that does not create any risk for the patient's blood pressure management. This complex interaction between two clinical frameworks is compounded by the many different possible patient variables and is especially cumbersome for patients presenting multiple clinical needs. A healthcare provider with access to the individual clinical frameworks for each of a patient's clinical needs would have a difficult time appreciating all the potential interactions and predicting the outcome of changing any of the appropriate clinical variables.

In modern clinical practice, clinicians may encounter knowledge-based expert systems that contain clinical information about specific clinical tasks or about specific patient conditions. When such expert systems are supplied with basic patient data, the expert system may supply as output a suggested therapy or course of action for a clinician to follow. The expert system typically consists of a set of rules. For example, expert systems may contain a set of rules associated with the prescription of medications

What is needed is a system and method for applying guidelines for clinical decision making to historical patient data. What is also needed is a system and method for the interactive manipulation of relevant clinical variables and the display of predicted outcomes based on such interactive manipulation. Such a system and method may take advantage of the combination of existing expert systems to provide multifaceted predictive analysis of a patient's condition.

### BRIEF SUMMARY OF THE INVENTION

Certain embodiments of the present invention include a method for predictive modeling of patient outcomes. The predictive method includes the steps of applying an algorithm to patient data and displaying predicted patient data. The predictive method may further include the step of adjusting one or more clinical variables.

Certain embodiments of the present invention include a system for modeling patient outcomes based on historical patient data. The system includes a database of patient data, a rules engine operably connected to the database wherein the rules engine is capable of applying algorithms to the patient data to generate predicted patient data, and a user interface operably connected to the database.

### BRIEF DESCRIPTION OF SEVERAL VIEWS OF THE DRAWINGS

FIG. 1 illustrates a user interface displaying a historical data chart for a fictional patient.

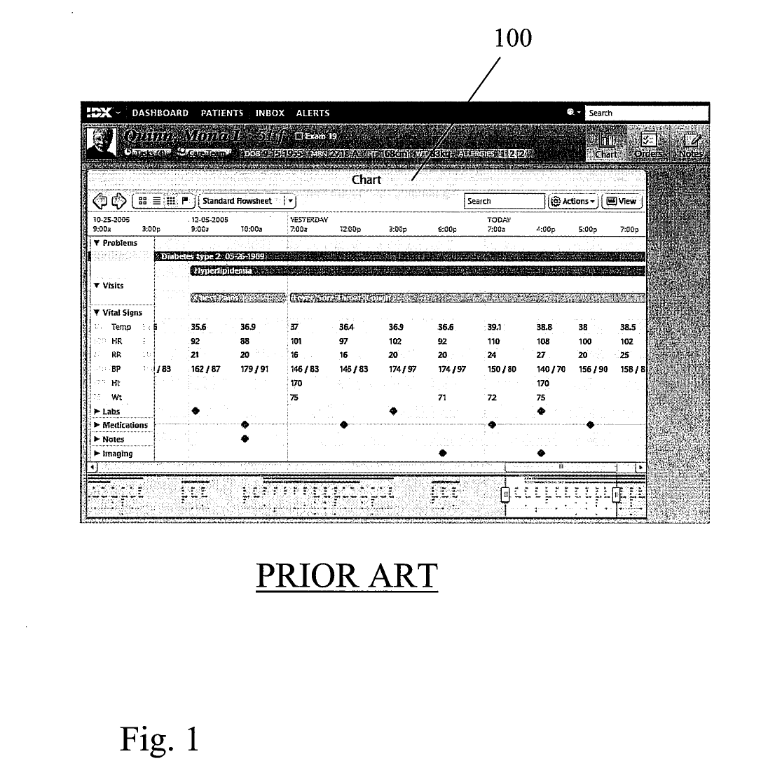

FIG. 2 illustrates a user interface displaying a historical trend chart for a fictional patient.

FIG. 3 illustrates a flowchart for a method of predictive modeling of patient data in accordance with an embodiment of the invention.

FIG. 4 illustrates a flowchart for a clinical guideline algorithm in accordance with an embodiment of the invention.

FIG. 5 illustrates a user interface displaying a historical trend chart and predicted patient trend data for a fictional patient in accordance with an embodiment of the invention.

FIG. 6 illustrates a user interface displaying a multifactor decision diagram in accordance with an embodiment of the invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentalities shown in the attached drawings.

### DETAILED DESCRIPTION OF THE INVENTION

The methods of certain embodiments of the present invention may be carried out using the types of computer systems commonly available in the modern healthcare environment. These computer systems are often networked systems having data stores or databases and workstations allowing clinical users to view and otherwise interact with patient data. The workstations may include user interface devices, such as keyboards or touchscreens.

The components and/or functionality of system may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a general purpose computer or other processing device, such as, for example, a workstation.

Certain embodiments of the present system and method make use of clinical guidelines or a clinical framework. The terms clinical guidelines or clinical framework refer to clinical protocols and practices for managing patient needs. For example, clinical guidelines include the protocol for treating a patient who has presented with a certain condition, such as high blood pressure. The guidelines for treating a patient with high blood pressure may include, for example, counseling regarding nutrition and smoking cessation. The guidelines for treating a patient with high blood pressure may also include prescribing a specific dosing profile of an appropriate pharmaceutical. The clinical guidelines for such a dosing profile may, in turn, depend on other factors such as patient age, weight, or reproductive status. It should be understood that the clinical guidelines may be substantially more complex than this example; this example is simplified for clarity.

Clinical guidelines may exist for a single condition, or they may exist in complementary fashion for multiple conditions often associated with one another. The clinical guidelines or framework may also change over time, as the standard of care for a given condition changes. The clinical frameworks have as a basis the empirical data generated by clinical practice and clinical trials, and may also change over time with the introduction of new pharmaceuticals or other treatment modalities. The present system and method is not limited to the current standards of care or clinical practices.

The clinical guidelines or clinical frameworks employed in conjunction with certain embodiments may leverage existing expert systems, or may involve the development of new expert systems. Expert systems contain clinical knowledge, usually about a very specifically defined condition, diagnosis, or treatment, and are able generate reasoned conclusions concerning individual patients. For example, an expert system can help in the formulation of likely diagnoses based on existing patient data in complex cases where diagnostic assistance is needed. Such systems may be leveraged into the rules engines that apply the clinical frameworks.

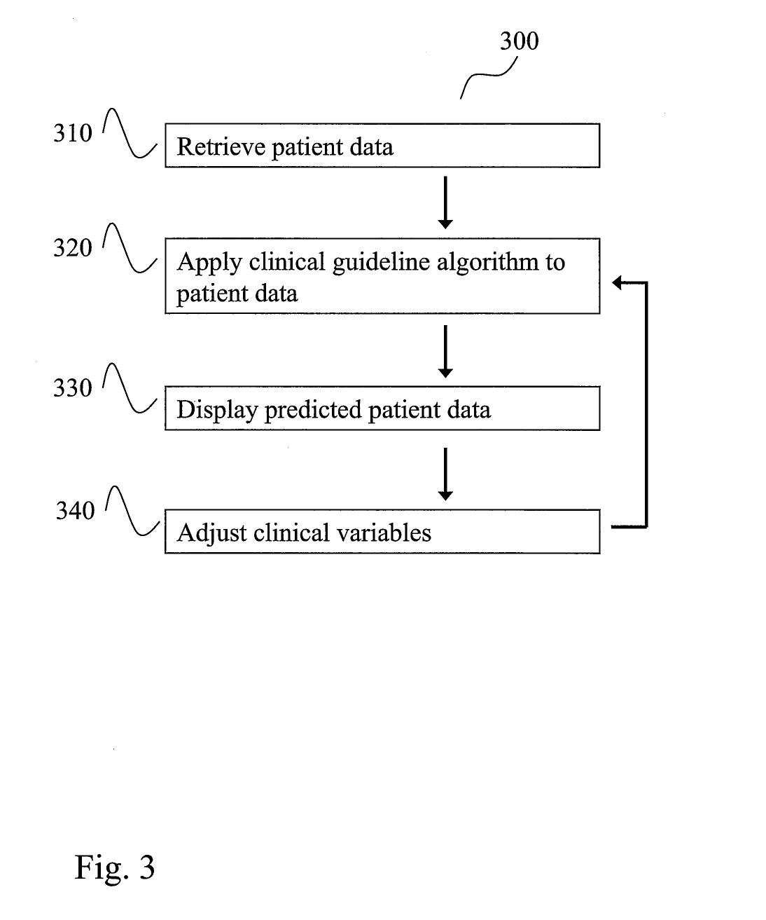

FIG. 3 illustrates a flowchart for a method 300 of predictive modeling of patient data in accordance with an embodiment of the invention. According to method 300, patient data is retrieved through patient data retrieval step 310. The patient data may include data that has recently been collected as well as historical patient data. The patient data may be stored locally at a workstation or it may be stored in a database, data storage system, or other data archive connected via a network to the workstation. Patient data retrieval step 310 may include retrieving patient data from multiple sources, including data archives containing patient demographic data and data archives containing patient diagnostic data, such as image archives for radiology or other specialized data archives.

According to certain embodiments of the present invention, patient data retrieval step 310 may include identifying the source of some or all of a given patient's data but not physically retrieving the data. That is, the output of patient data retrieval step 310 may simply be a list of network locations where patient data is stored and not the actual patient data. Thus, patient data retrieval step 310 provides access to relevant patient data regardless of whether the patient data is copied, moved, or otherwise transferred from one network location to another, according to certain embodiments of the present invention. Moreover, in certain embodiments of the present invention, patient data retrieval 310 may not occur as a separate step from another step in the method, or it may occur as a subset of another step in the method.

Referring again to FIG. 3, according to certain embodiments of the present invention, an algorithm is applied to the patient data in algorithm step 320. Algorithm step 320 is the step in which the clinical framework or clinical guidelines are applied to the patient data to generate the predicted data or data trends for a patient. An embodiment of an algorithm that may be applied in algorithm step 320 is described in more detail below.

In certain embodiments of the present invention, algorithm step 320 may include multiple substeps that apply different algorithms to the same set of patient data. For example, certain algorithms that have clinical frameworks that are specific to a certain disease state, such as Type 2 diabetes, may be applied to the patient data alone or in conjunction with other disease-specific clinical frameworks. Thus, algorithm step 320 may not simply apply a single, global algorithm to the patient data but may instead apply a series or a set of specific algorithms, and each algorithm may be of varying scope. Moreover, algorithm step 320 may apply an algorithm to the data output from another algorithm. In other words, the clinical framework for the treatment of a first disease state may dominate the clinical framework for the treatment of another disease state in such a way that the historical patient data is run through first algorithm and only the results of the first algorithm are used as the data input for the second algorithm. Further, multiple algorithms may depend on the output of other algorithms, as dictated by the clinical frameworks involved in a specific patient's data modeling.

Referring again to FIG. 3, the data output from algorithm step 320 is displayed in data display step 330, according to certain embodiments of the present invention. Data display step 330 provides a clinician the opportunity to view and examine the results of the predictive algorithm as applied to the patient data. Data display step 330 may display the results of the algorithm on a workstation or on other displays connected to a network. The data may be displayed as trends, or the data may be displayed as discrete, predicted data points corresponding to points in time.

Referring again to FIG. 3, a clinician may adjust certain clinical variables in adjusting step 340, according to certain embodiments of the present invention. In order to adjust certain clinical variables, a clinician may employ a user interface device such as a keyboard or a touchscreen. The clinician may adjust as many clinical variables as the clinical guidelines permit. After certain variables have been adjusted by the clinician, algorithm step 320 may again apply the relevant clinical guidelines to the adjusted variables, according to certain embodiments of the present invention. In that sense, the adjusted variables may constitute another form of patient data to which the clinical framework or guidelines may be applied. Algorithm step 320 may not apply the full algorithm to the adjusted variables, but may instead apply only those parts of the algorithm that are affected by the change in variables. Such discrete application of a clinical framework may be governed by the rules engine that is described in more detail below.

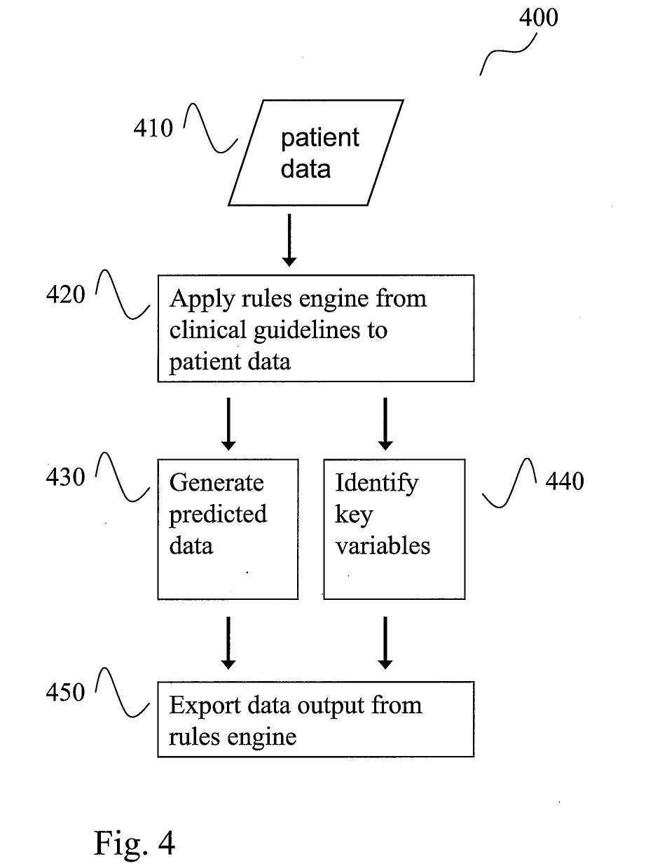

FIG. 4 illustrates a flowchart for a clinical guideline algorithm 400 in accordance with an embodiment of the invention. Algorithm 400 is an embodiment of the algorithms that may be applied to patient data in algorithm step 320 of FIG. 3 according to certain embodiments of the present invention. Algorithm 400 takes input in the form of patient data 410. Patient data 410 may include data that has recently been collected as well as historical patient data. Patient data 410 may also include clinical variables that have been interactively adjusted by a clinician as part of adjusting step 340 of FIG. 3 according to certain embodiments of the present invention.

Still referring to FIG. 4, patient data 410 is data input for rules engine step 420 in which the rules associated with a clinical framework are applied to patient data via a rules engine, according to certain embodiments of the present invention. The rules engine is capable of evaluating input data, such as patient data, based at least in part on one or more rules. A rule may include a condition component and a result component. The input patient data is evaluated by the condition component of a given rule in the rules engine. If the rules engine determines that the condition component of the rule is met by input patient data, the rules engine may then propose a result component for future patient data.

The condition component may include several factors and/or variables to be evaluated with various dependencies between them. Dependencies may include, for example, Boolean operators such as “AND,” “OR,” and “NEITHER.” The condition component may include a variety of conditions specified by an expression or operator such as “equal to,” “less than,” “greater than,” “drop by %,” and “increased by.” In addition, an expression or operator included in the condition component may include a temporal characteristic. For example, the expression might be “within the past hour” or “over one day ago.”

A rule may be implemented as a table, interpreted code, database query, or other data structure, for example. A rule may be represented in a variety of ways known to one having ordinary skill in the art. A rule may be implemented as content in a database, for example. The database may store, for example, a rule type, criteria, operator, and value. The database may contain a rule identifier with one to many criteria pairs such as “criteria=glucose level, operator=rises, value=2%,” for example.

Referring again to FIG. 4, one result of rules engine step 420 is that predicted patient data may be generated in data generating step 430, according to certain embodiments of the present invention. The rules engine, or engines, in rules engine step 420 apply the rules-based versions of the clinical frameworks to the input patient data to yield predicted data.

Referring again to FIG. 4, another result of rules engine step 420 is that certain key variables may be identified in key variable identifying step 440, according to certain embodiments of the present invention. In addition to generating predicted data in data generating step 430, rules engine step 440 may identify key variables to facilitate the clinician's interaction with the system and method. Key variables include certain variables that may have more influence over changes in the predicted patient trends than other variables. By identifying such key variables, the system and method of certain embodiments of the present invention may enhance the clinician's ability to manipulate patient treatment conditions and thereby optimize possible patient outcomes.

Moreover, the rules engine applying the clinical framework may determine that altering certain clinical variables will have minimal or no effect on patient outcomes for a particular patient condition. In that case, key variable identifying step 440 may identify variables that will have minimal or no effect on patient outcomes and flag them as variables that should not be manipulated during the interactive process.

Referring again to FIG. 4, both the predicted data and the key variables are exported as output in data export step 450, according to certain embodiments of the present invention. The data may be exported for display in a user interface for review and possible manipulation by a clinician.

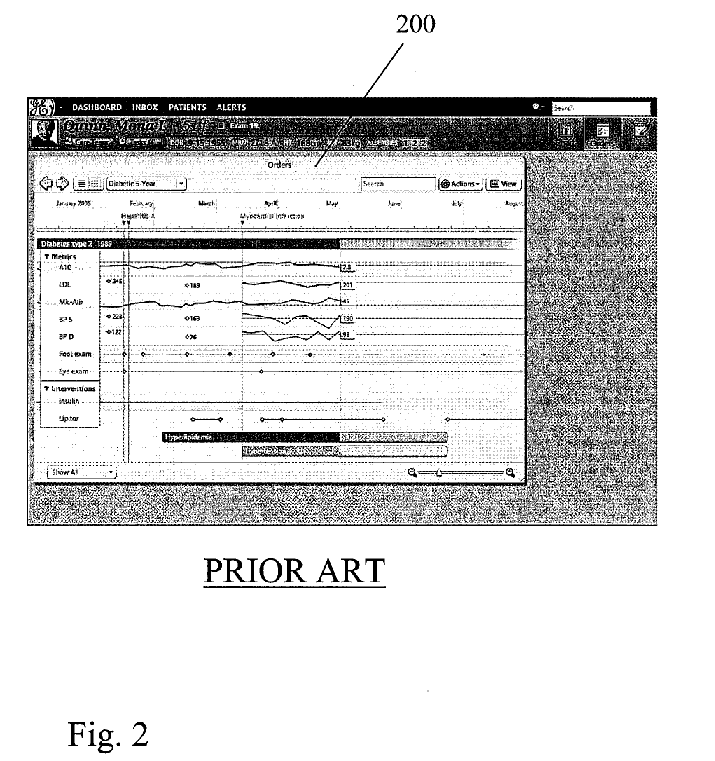

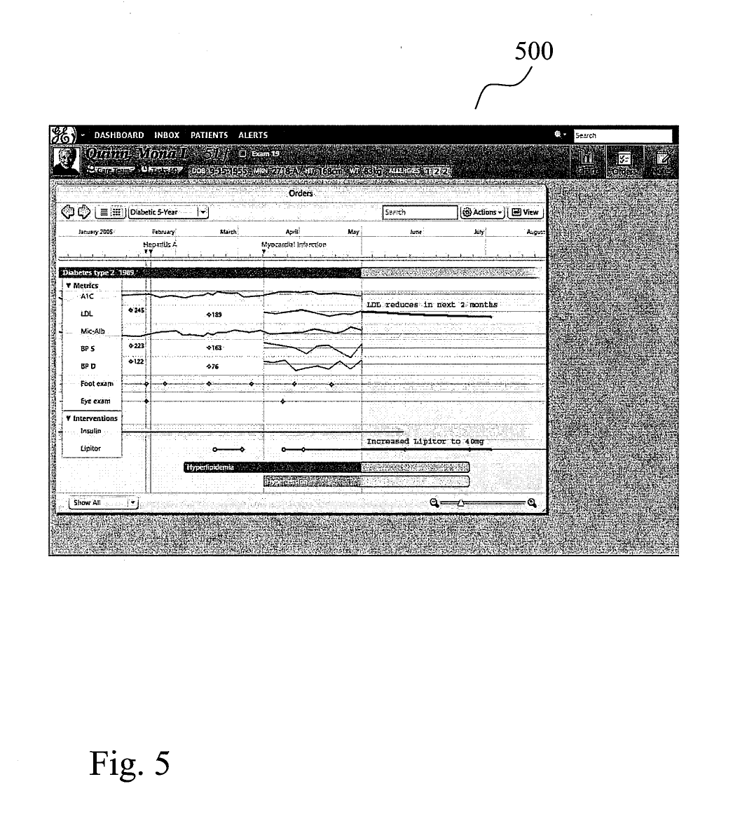

FIG. 5 illustrates a user interface displaying a historical and predicted data trend chart 500 for a fictional patient according to certain embodiments of the present invention. Similar to historical data trend chart 200 in FIG. 2, historical and predicted data trend chart 500 provides a clinician with a view of a patient's historical data profile as compared to time in order to visually depicted past trends in a patient's condition. Additionally, historical and predicted data trend chart 500 provides a predicted trend line based on the manipulation of clinical variables. For example, increasing the dosage level of a certain drug, Lipitor, in the example depicted in FIG. 5, has a predicted effect of reducing the LDL of a fictional patient over a two month period.

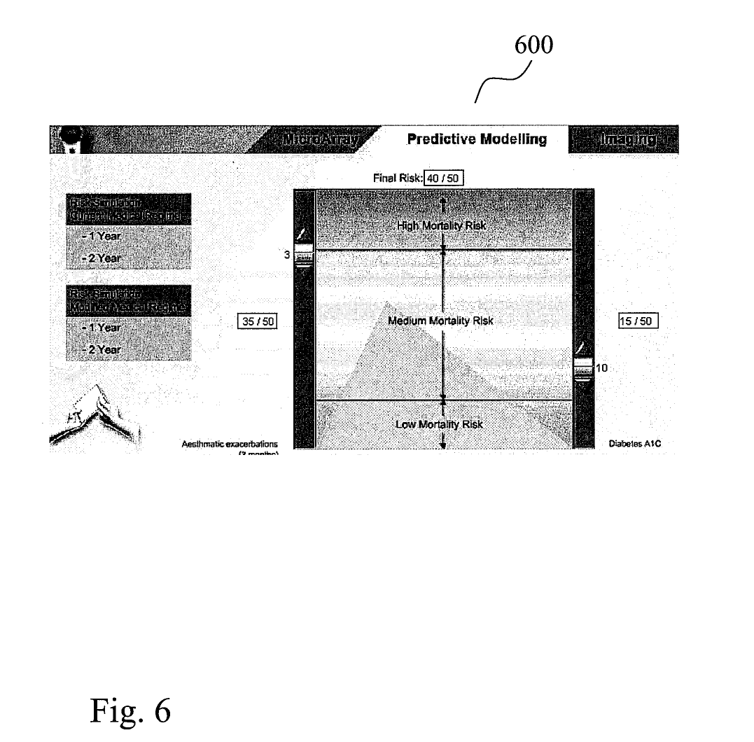

FIG. 6 illustrates a user interface displaying a multifactor decision diagram 600 in accordance with certain embodiments of the invention. In multifactor decision diagram 600, the dependence of the mortality risk for a fictional patient is represented diagrammatically. In this example, the mortality risk depends on at least two variables, asthmatic encounters and diabetes A1C levels.

Referring again to FIG. 6, multifactor decision diagram 600 provides a graphical user interface for manipulation of clinical variables. The range of variables is graphically presented, as is the means for manipulating the variables. However, the interface need not be entirely graphical. Certain embodiments of the present invention may use a variable configuration panel. A variable configuration panel may allow a user to specify an operator or expression for use in evaluating the item, factor, and/or variable. For example, a list may include “drop by %.” Operators and/or expressions may include, for example, Boolean operators such as “AND,” “OR,” and “NEITHER,” for example. As another example, the operators and/or expression may include a variety of conditions specified by an expression or operator such as “equal to,” “less than,” “greater than,” “drop by %,” and “increased by.” In addition, an expression or operator may include a temporal characteristic. For example, the expression might be “within the past hour” or “over one day ago.”

Multiple items, factors, and/or variables may be added to the variables being evaluated using the variable configuration panel. For example, the predictive model may include several factors and/or variables to be evaluated with various dependencies between them. Dependencies may include, for example, Boolean operators such as “AND” and “OR.” Another operator may be the “EXISTS” operator, for example. The “EXISTS” operator may be used to determine if, for example, an order exists or if a patient has a particular allergy.

Thus, various embodiments of the present system and method provide for the application of guidelines for clinical decision making to historical patient data. Certain embodiments of the present system and method provide for the interactive manipulation of relevant clinical variables and the display of predicted outcomes based on such interactive manipulation. Various embodiments of the present system and method provide the ability for a clinician to interactively visualize the impact of a specific intervention/treatment plan over time. Various embodiments of the present system and method allow healthcare professionals the ability to adjust variables such as dosage, interval and duration of a specific drug or interventional procedure over time and view the computer derived projections. Various embodiments of the present system and method provide the healthcare professional the ability to plan an intervention specific to a particular patient as opposed to leveraging the “cookie-cutter” templates provided in clinical reference manuals.

Certain embodiments of the present system and method employ a predictive modeling engine that is able to leverage existing, historical patient data with healthcare interventional plans consisting of current best-in-breed clinical guidelines. For example, based on a particular patient's trends for a particular lab value, measurement, or vital sign, an algorithm that leverages the current intervention plan is able to derive or predict what the value will be based on specific dosage, durations, and other variables. The resulting predictive information can be displayed in the context of a line chart that highlights the historical, actual data with predictive data that differentiates from the historical data. Such differentiation can occur by means of color, line weight, line symbol, or other graphical means. Certain embodiments of the present system and method provide healthcare professionals with the ability to interactively increase or decrease clinical variables such as dose, duration, or interval with the various intervention plans to visualize the potential impact of this specific intervention plan.

### EXAMPLES

In one example of an embodiment of the present invention, Lipitor dosage has been increased 50% over a two month period. Based on this patient's past medical history with this drug, other drug interactions and current best-in-class clinical guidelines, a computer algorithm is able to predict an LDL cholesterol level for this patient. It should be understood that this example is simplified for clarity. FIG. 5 depicts a historical and predicted data trend chart 500 consistent with this example.

In another example of an embodiment of the present invention, a patient's mortality risk is projected as it relates to a surgical procedure. Based on how a physician is able to manage the patient's Diabetes A1C levels and Asthmatic encounters, the mortality risk can be interactively set to display what the patient's mortality risk would be for a given procedure. It should be understood that this example is simplified for clarity. FIG. 6 depicts a multifactor decision diagram 600 consistent with this example.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for predictive modeling of patient outcomes comprising the steps of:
applying an algorithm to patient data; and
displaying predicted patient data.

2. The method of claim 1 further comprising adjusting one or more clinical variables.

3. The method of claim 1 wherein the patient data is selected from the group consisting of historical data, current data, or both.

4. The method of claim 3 wherein the patient data is retrieved from a data archive.

5. The method of claim 2 wherein the algorithm applies clinical guidelines to the patient data.

6. The method of claim 1 wherein the one or more clinical variables are selected from the group consisting of patient vitals, laboratory measurements, and dosing profiles.

7. The method of claim 2 wherein at least one clinical variable remains fixed based on the clinical guidelines.

8. The method of claim 5 wherein the clinical guidelines further define ranges for the adjustment of the one or more clinical variables.

9. The method of claim 1 further comprising the step of displaying patient historical data.

10. The method of claim 9 wherein the predicted patient data is displayed concurrently with the patient historical data.

11. A system for modeling patient outcomes based on historical patient data comprising;
a database of patient data;
a rules engine operably connected to the database wherein the rules engine is capable of applying algorithms to the patient data to generate predicted patient data; and
a user interface operably connected to the database and the rules engine, wherein the user interface is capable of receiving user input, providing the user input to the rules engine, and displaying predicted patient data generated by the rules engine.

12. The system of claim 11 wherein the database, rules engine, and user interface are operably connected via a network.

13. The system of claim 11 wherein the database is a data archive.

14. The system of claim 11 wherein the rules engine comprises at least one set of rules that apply at least one set of clinical guidelines to the patient data.

15. The system of claim 14 wherein the rules engine comprises multiple sets of rules that apply multiple sets of clinical guidelines to the patient data.

16. The system of claim 15 wherein the results of the application of at least one of the multiple sets of rules varies according to the results of the application of at least another one of the multiple sets of rules.

17. A computer readable storage medium including a set of instructions for a computer, the set of instructions comprising:
a data retrieval routine, wherein the data retrieval routine retrieves patient data;
a rules routine, wherein the rules routine applies clinical guidelines to the patient data; and
a user interface.

18. The computer readable storage medium of claim 17, wherein the set of instructions further comprises a display routine for displaying predicted patient data.

19. The computer readable storage medium of claim 17, wherein the rules routine identifies key variables and fixed variables.

20. The computer readable storage medium of claim 17, wherein the user interface is a graphical user interface.
